(19) United States
(12) Patent Application Publication
(10) Pub. No.: US 2013/0077556 A1
(43) Pub. Date: Mar. 28, 2013

(54) SETTING GAINS IN AN INTERFERENCE CANCELLATION REPEATER BASED ON PATH LOSS

(71) Applicants: Dhananjay Ashok Gore, Bangalore (IN); Gwendolyn Denise Barriac, Encinitas, CA (US)

(72) Inventors: Dhananjay Ashok Gore, Bangalore (IN); Gwendolyn Denise Barriac, Encinitas, CA (US)

(73) Assignee: QUALCOMM Incorporated, San Diego, CA (US)

(21) Appl. No.: 13/243,822

(22) Filed: Sep. 23, 2011

(51) Int. Cl. H04B 15/00; H04B 7/15; H04W 92/00; H04B 7/14

(52) U.S. Cl. 370/315

(57) ABSTRACT

A method of controlling gains in an interference cancellation repeater includes receiving a combined signal which comprises a downlink signal transmitted from a base station transceiver system (BTS) and a feedback signal. The method further includes performing interference cancellation on the combined signal to substantially remove the feedback signal from the downlink signal. The method further includes determining a path loss between the BTS and the interference cancellation repeater based on the downlink signal after interference cancellation is performed, and adjusting at least one gain in the interference cancellation repeater based on the path loss. An interference cancellation repeater which controls gains based on a downlink path loss includes a first and second transceiver coupled to a first and second antenna, respectively, and a baseband processor configure to perform the above method.

### REFERENCE TO CO-PENDING APPLICATIONS FOR PATENT

The present Application for Patent is related to the following co-pending U.S. patent application Ser. No.: “ADJUSTING REPEATER GAINS BASED UPON RECEIVED DOWNLINK POWER LEVEL” by Gainey, et al., filed concurrently herewith, having Attorney Docket No. 093272, assigned to the assignee hereof, and expressly incorporated by reference.

### FIELD

Aspects of this disclosure generally relate to wireless communication systems, and more specifically, for making gain adjustments in interference cancellation repeaters based on path loss.

### BACKGROUND

In wireless communication systems, mobile stations (MSs) may exchange signals with one or more base station terminal systems (BTSs) which can provide service within a surrounding geographic region. A coordinated network of BTSs may provide wireless communication service to an expansive coverage area. However, due to various geographic, electromagnetic and/or economic constraints, the network of BTSs may lack adequate communication services in some areas within a desired coverage area. These “gaps” or “holes” in the coverage area may be filled with the use of repeaters.

Generally, a repeater is a high gain bi-directional amplifier. Repeaters can receive, amplify and re-transmit signals in both the uplink direction (from the MS to the BTS) and the downlink direction (from the BTS to the MS). The repeater may provide communication service to the coverage hole, which was previously not adequately serviced by the BTS. Repeaters may also augment the coverage area of a sector by shifting the location of the coverage area or altering the shape of the coverage area. In conventional repeaters, a standard offset between the uplink and downlink levels may be used as a fixed repeater gain. However, MSs using the repeater may be at various distances and may utilize differing signal strengths, and thus could benefit from a variable repeater gain. Moreover, in communications systems where controlling power is important to good system performance (e.g., CDMA systems), each MS within a cell may have its power settings under direct control of the serving BTS. Conventional repeaters having a fixed repeater gain may not be amenable to these standard types of BTS power control.

In addition, a repeater is not a noiseless device and may contribute additional noise into the receiver at the BTS. While one repeater may not appreciably increase the noise floor at the BTS, the cumulative effect of many repeaters may noticeably raise the noise floor of the BTS, thereby reducing the effectiveness of the communication links in the coverage area. Conventional approaches to mitigating repeater noise may include noise gating, which can include turning the repeater transmitter off when there is no input signal and only thermal noise is seen at the repeater's input. However, such an approach can make it difficult for the repeater to achieve maximum power quickly enough to when burst data is received. Simply limiting the uplink gain would reduce the thermal noise, but given the power coupling between the BTS and the MS resulting from the open and closed loop power control algorithms, unilateral changes in uplink gain will influence the downlink gain, which could adversely affect repeater performance.

Moreover, some repeaters may perform various signal processing operations in the digital domain (e.g., interference cancellation repeaters designed to reduce feedback between uplink and downlink channels). Accordingly, these repeaters will use analog-to-digital converters (ADCs) which typically require the dynamic range of the analog signal input to be within a designated range, depending upon the number of bits output by the ADC. If the input analog signal exceeds the dynamic range of the ADC, non-linear forms of noise may result. For example, if the input analog signal is too low, quantization noise may become dominant and significantly degrade the digital conversion process. At the other extreme, if the input analog signal level is too high, the full scale value of the ADC's output will be exceeded and the input signal will be clipped, thus causing severe non-linear distortions.

Conventional approaches to avoid these types of non-linear distortion typically involve automatic gain controllers (AGCs) to limit the dynamic range of the analog signal so that it “fits” into the ADC. However, for interference cancellation repeaters, the AGC prevents accurately estimating the feedback channel because step changes in signal amplitudes can cause oscillations. Accordingly, for interference cancellation repeaters, the ADCs conventionally utilize a wider dynamic range (i.e., a large number of bits) in order to properly accommodate the wide range in levels of the input signals, which include both the communication signals and the feedback signals appearing at the front end of the repeater. Utilizing ADCs capable of accepting such wide dynamic ranges increases costs, both for the ADC components themselves, and for subsequent digital components having to accommodate more bits being provided by the ADCs.

Accordingly, it may be desirable to adjust the gain within the repeaters using simple and cost effective techniques in order to reduce the noise floor seen at the receiver of the BTS, and to reduce costs of the ADCs and associated digital components in digital signal processing repeaters.

### SUMMARY

Exemplary embodiments of the invention are directed to systems and methods for setting gains in an interference cancellation repeater based on path loss.

In one embodiment, a method of controlling gains in an interference cancellation repeater is provided. The method may include receiving a combined signal which comprises a downlink signal transmitted from a base station transceiver system (BTS) and a feedback signal. The method may further include performing interference cancellation on the combined signal to substantially remove the feedback signal from the downlink signal. The method may further include determining a path loss between the BTS and the interference cancellation repeater based on the downlink signal after interference cancellation is performed, and include adjusting at least one gain in the interference cancellation repeater based on the path loss.

In another embodiment, an interference cancellation repeater (ICS) which controls gains based on a downlink path loss is provided. The ICS may include a first transceiver coupled to a donor antenna, and a second transceiver coupled to a serving antenna. The ICS may further include a baseband processor coupled to the first transceiver and the second transceiver. The baseband processor may be configured to receive a combined signal which comprises a downlink signal transmitted from a base station transceiver system (BTS) and a feedback signal. The baseband processor may be further configured to perform interference cancellation on the combined signal to substantially remove the feedback signal from the downlink signal. The baseband processor may be further configured to determine the path loss between the BTS and the interference cancellation repeater based on the downlink signal, and adjust at least one gain in the interference-cancellation repeater based on the path loss.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a block diagram of a system using a digital baseband interference cancellation repeater (ICR).

FIG. 2 shows a block diagram of an exemplary interference cancellation repeater which can adjust a link imbalance based on path loss to reduce noise at the base station terminal system (BTS).

FIG. 3 depicts a flow chart of an exemplary process for mitigating the noise contribution of the ICR at the BTS by adjusting a link imbalance based on path loss.

FIG. 4 shows a block diagram of an exemplary ICR which can adjust a link imbalance and/or an RF amplifier gain based on path loss to improve signal quantization.

FIG. 5 illustrates a flow chart of an exemplary process for improving the quantization performance of the uplink channel in the ICR based on path loss.

FIG. 6 shows another block diagram of an exemplary ICR consistent with embodiments of the disclosure.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

### Overview

Embodiments presented herein may be directed to interference cancellation repeaters (ICRs) which utilize an estimated path loss to adjust various gains within the ICR. The estimated path loss may be derived from measurements of the signal level received from a base station downlink signal. The gain adjustments can be performed to improve signal quantizing performance and/or manage the ICR's noise contribution at a base station terminal system (BTS) receiver. While path loss is typically thought of as signal degrading phenomena within a wireless channel, for embodiments provided herein, the path loss between the BTS and an ICR may be exploited to help reduce noise seen at the BTS receiver which is induced by the ICR.

In one embodiment, the digital gains of the ICR in the uplink channel and the downlink channel may be adjusted based on path loss to maintain the noise contribution of the ICR at the receiver of the BTS at an acceptable level. This may be accomplished by setting the “gain caps” in the uplink and/or downlink channels of the ICR. As used herein, gain caps are limits as to how much gain may be applied in a particular channel. As the path loss increases, the gains on the uplink may be correspondingly higher while maintaining the same uplink noise. Similarly, as the path loss decreases, the uplink gains should be reduced in order to keep the noise at the BTS from rising. The downlink gain should not be independent of the uplink gain since some algorithms at the BTS and MS assume a certain degree of similarity in the uplink and downlink path loss, and hence if the uplink gain is capped, the downlink gain should be similarly capped. However, these algorithms do allow for some margin, which can be exploited at the ICR. Thus, the ICR can introduce a higher link imbalance when the path loss is low, so as not to degrade the downlink performance simply because the uplink gains need to be set low to maintain appropriate noise levels at the BTS. As used herein, the term “link imbalance” refers to a set gain offset between the uplink channel and the downlink channel of the ICR.

In another embodiment, at least one gain within the ICR may be adjusted based on path loss to control the level of the signal for improving quantization performance. Here, the uplink gain may be adjusted so the level of the mobile signal received on the uplink of the ICR is changed to improve analog to digital conversion at the ICR on the uplink. This technique takes advantage of the power control operating in the mobile station, thus indirectly controlling (at the repeater) the output of the mobile station's transmit signal level. In another embodiment, an uplink RF gain may be directly adjusted to vary the signal level provided to the ADC, so the signal level is placed within the dynamic range of the ADC to improve analog to digital conversion and reduce quantization noise. Moreover, adjusting the signal provided to the ADC may relax its dynamic range requirements, thus allowing for a less expensive ADC to be used.

In other embodiments, these aforementioned techniques may be combined to mitigate uplink noise at the base station and/or also improve ADC performance. Various embodiments are presented in more detail below.

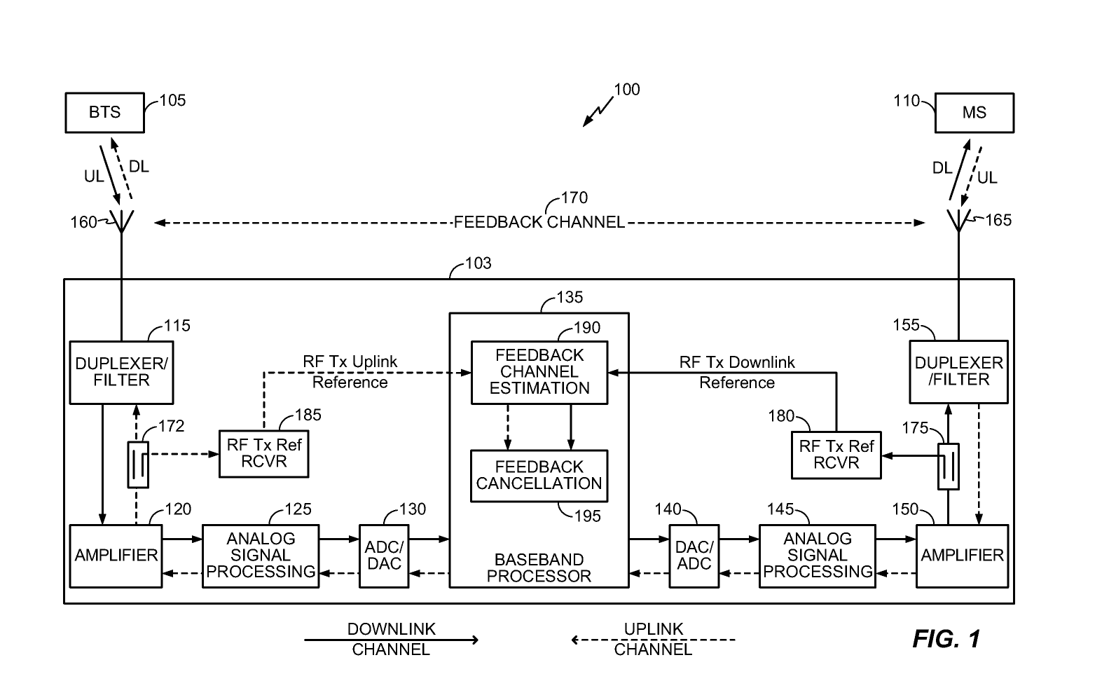

FIG. 1 is a block diagram of a system 100 using a digital baseband interference cancellation repeater (ICR) 103. The ICR 103 may simultaneously exchange signals with a Base station Transceiver System (BTS) 105 and at least one mobile station (MS) 110 (only one MS is shown in FIG. 1). Signals traveling from the BTS 105, through the ICR 103, towards the MS 110 are said to be on the “downlink.” Signals travelling from the MS 110, through the ICR 103, towards the BTS 105 are said to be on the “uplink.”

The ICR 103 may retransmit a signal on the same frequency as which it was received. In a frequency division duplex repeater, the uplink and downlink signals are separated by two channels centered at different frequencies. Accordingly, the ICR 103 may transmit and receive simultaneously using separate uplink and downlink channels. In FIG. 1, for ease of explanation, blocks 120-150 comprising the uplink and downlink channels are shown in a combined bi-directional path, where the path going from left to right designated by solid arrows represents the downlink channel, and the path going from right to left designated by dashed arrows represents the uplink channel.

In certain realizations, where the entire ICR 103 is contained in an enclosure and antennas 160 and 165 are integral therein, the antennas 160, 165 may not provide sufficient isolation between the uplink and downlink channels within the ICR 103. When more gain is desired than isolation that exists between antennas 160 and 165, base band interference cancellation may be used to increase the stability of the ICR and increase the overall gain. This may be accomplished by actively cancelling out the transmitted signal provided over the feedback channel 170 using digital processing, as will be described in more detail below.

During operation, the downlink signal may be transmitted by BTS 105 and subsequently received by antenna 160. Also received by antenna 160 is a leakage signal, which is provided over a feedback channel 170, and superimposed on the downlink signal to produce a combined signal. The combined signal may be filtered into it separate uplink and downlink frequency bands and routed along the appropriate downlink channel by duplexer 115. The combined signal may be further processed in the analog domain by the analog signal processing block 125. The analog processing may include, for example, amplification using a low noise amplifier, and filtering using an RF Surface Acoustic Wave (SAW) filters. The analog signal processing block 125 may further down convert the combined signal to baseband, perform IQ conversion and additional filtering for alias rejection. The signal may then be digitized by an analog-to-digital converter (ADC) 130.

The digitized combined signal may be processed by a baseband processor 135 to isolate the downlink signal by substantially removing the leakage signal received over the feedback channel 170. The baseband processor 135 may actively cancel out the leakage signal by applying an appropriate channel filter to a transmit (Tx) reference signal to create the predicted feedback signal. Once the predicted feedback signal is determined, it can be subtracted from the combined signal by the baseband processor 135. The channel filter may be generated in a feedback channel estimation block 190.

Further referring to the downlink channel path, the channel estimate may be determined utilizing the appropriate RF Tx downlink reference signal, which in the embodiment shown in FIG. 1, may be obtained by tapping the transmit signal after amplification by amplifier 150 using RF coupler 175. An RF Tx reference receiver 180 may take the RF Tx downlink reference signal from the RF coupler 175 to process (e.g., down convert, filter, etc.) and digitize the signal so it may be feed back into the baseband processor 135 for use by the feedback channel estimation block 190. Feedback channel estimation block 190 can perform channel estimation of the feedback channel 170 using for example, frequency domain minimum means square error (MMSE) techniques. The leakage signal superimposed on the downlink signal may be cancelled out and removed by the baseband processor 135 by convolving the channel estimate with the digitized RF Tx downlink reference signal to obtain the estimated leakage signal. Once the estimated leakage signal is determined, it may be cancelled from the combined signal in feedback cancellation block 195 by inverting it (shifting it 180 degrees out of phase) and adding it to the combined signal.

In other embodiments (not shown), a digitized Tx downlink reference signal may be obtained directly from the ADC/DAC 130. However, using an RF Tx downlink reference signal as shown can have the advantage of allowing the channel estimation algorithms include and account for the distortions associated with the components of the transmitter chain (e.g., ADC/DAC 130, analog signal processor block 145, amplifier 150, etc.). This can improve the accuracy of the channel estimation and thus the interference cancellation, which in turn can improve the power transmitted from the amplifier 150 due to the increase isolation.

Further referring to the downlink channel in FIG. 1, once the leakage signal is removed, the downlink signal may be converted to an analog signal by DAC/ADC 140. The analog signal may be further processed in the analog domain by analog signal processing block 145. Analog signal processing block 145 may include image rejection filtering, IQ up-conversion, and further RF filtering using, for example, SAW filters for inter-channel interference. Finally, power amplification may be provided by RF power amplifier 150 The amplified signal may subsequently be passed on to duplexer/filter 155 for additional filtering to separate the downlink and uplink channels, and routed to antenna 165 for downlink transmission to the MS 110.

Uplink signals provided by the MS 110 may be simultaneously received by antenna 165. Similar to the downlink channel described above, a leakage signal, provided over feedback channel 170 transmitted by antenna 160, is superimposed on the uplink channel at antenna 165. The combined signal is provided to duplexer/filter 155 which filters the combined signal, and routes the signal over the appropriate uplink channel in the ICR. In FIG. 1, the uplink channel is shown in dashed lines and shares the same processing blocks with the downlink channel to simplify the diagram. The processing occurring in the uplink channel proceeds in the opposite direction from right to left in FIG. 1, but may be basically the same as described above in the downlink channel. It should be noted that the uplink channel may perform a separate feedback channel estimation which may use a separate RF Tx uplink reference signal to facilitate the channel estimation. The RF Tx uplink reference may tap off of the amplifier 120 output using RF coupler 172. The analog RF signal may be provided to RF Tx Ref receiver 185 for processing and digitization. The digitized RF Tx uplink reference signal may then be provided to baseband processor 135 so that the feedback channel for the uplink channel may be estimated by the feedback channel estimation block 190. Similar in the manner described above for the downlink channel, the feedback channel estimate for the uplink channel may be used in conjunction with the tx reference samples to remove the leakage signal from the combined uplink signal received over antenna 165.

In a conventional ICR, as the overall gain of the repeater is increased, the leakage signal becomes proportionally larger. This increases the dynamic range of the combined signal in the uplink and downlink channels. This results in utilizing analog-to-digital converters having a higher dynamic range to avoid non-linear quantization errors/saturation, which increases the component costs of the repeater. The increased dynamic range may further result in received signal de-sensitization, can limit the transmitter output levels, and increase the noise contribution at the base station receiver.

As used herein, MS 110 may refer to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile station.”

BTS 105 may be part of terrestrial based communication systems and networks that include a plurality of PCS/cellular communication cell-sites. They can be associated with CDMA or TDMA (or hybrid CDMA/TDMA) digital communication systems, transferring CDMA or TDMA type signals to or from remote stations. Signals can be formatted in accordance with IMT-2000/UMTS standards, using WCDMA, CDMA2000 or TD-SCDMA type signals. On the other hand, the base station 105 can be associated with an analog based communication system (such as AMPS), and transfer analog based communication signals.

The embodiments described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

### Mitigating Repeater Noise Contribution at BTS

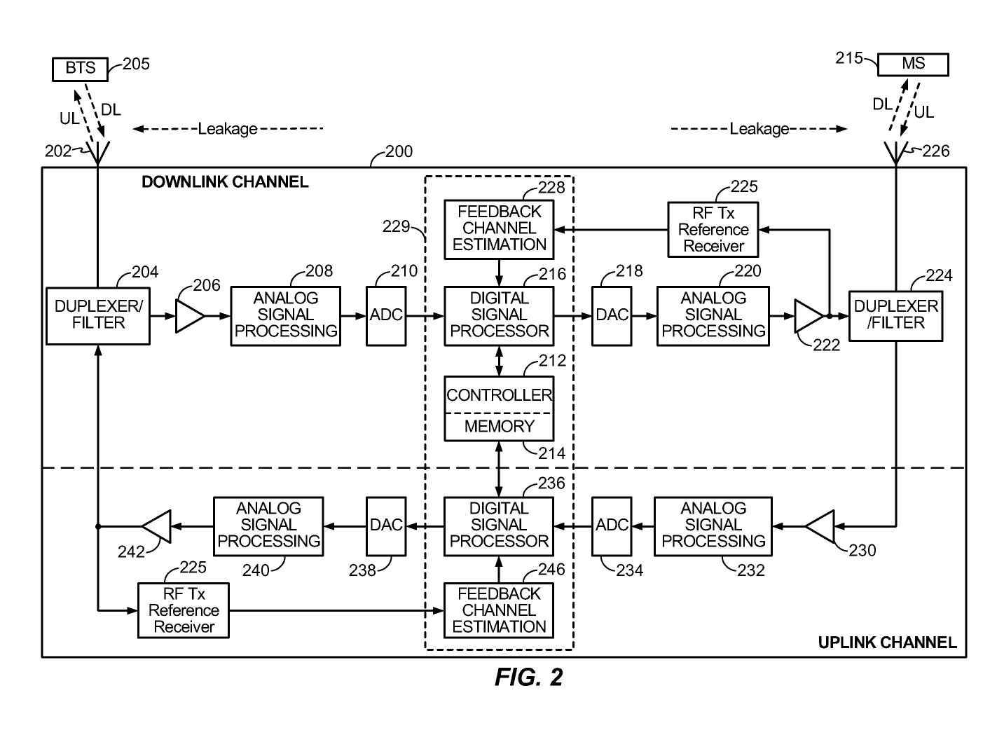

By leveraging the path loss information which can be determined from the measured downlink signal transmitted by the BTS 105, one can appropriately set the digital gains on the uplink and/or downlink (and thus affect the link imbalance) of the ICR to reduce its noise contribution at the BTS. FIG. 2 shows a block diagram of an exemplary Frequency Division Duplex (FDD) digital base-band interference cancellation repeater (ICR) 200 which may operate in this manner.

The ICR 200 may receive at antenna 202 a downlink signal from a BTS 205 and a leakage signal from antenna 226. The combined downlink signal may be provided to duplexer/filter 204 which may perform filtering and appropriate switching of signals to separate the downlink and the uplink signals. In the case of a received downlink signal, the duplexer/filter 204 will route the combined signal to the downlink channel. The combined downlink signal may be amplified by low noise amplifier 206 to increase its gain. The combined downlink signal may be further processed in the analog domain by the analog signal processing block 208. The analog processing may include, for example, filtering using an RF Surface Acoustic Wave (SAW) filters, down conversion to baseband, performing IQ conversion, and additional filtering for alias rejection. The combined downlink signal may then be digitized by an analog-to-digital converter (ADC) 210.

The digitized combined downlink signal may be processed by a baseband processor 229 to remove the leakage signal received over the feedback channel. The baseband processor may include at least one digital signal processor (e.g., 216 and 236), at least one controller 212 and associated memory 214, and at least one feedback estimation block (e.g., 228, 246). The digital signal processor 216 may actively cancel out the leakage signal by applying an appropriate channel filter to a transmit (Tx) reference signal to create a predicted feedback signal. Once the predicted feedback signal is determined, it can be subtracted from the combined downlink signal by the digital signal processor 216. The channel filter may be generated in a feedback channel estimation block 228.

Further referring to the downlink channel, the feedback channel estimate may be determined utilizing the appropriate Tx downlink reference signal which may be obtained by tapping the transmit signal after amplification by an amplifier 222. An RF Tx reference receiver 225 may take the RF Tx downlink reference signal from an RF coupler (not shown) to process (e.g., down convert, filter, etc.) and digitize the signal so it may be fed back into the baseband processor 229 for use by the feedback channel estimation block 228. Feedback channel estimation block 228 can perform channel estimation of the feedback channel using, for example, minimum mean square error (MMSE) techniques.

The leakage signal superimposed on the downlink signal may be cancelled out and removed by the digital signal processor 216 by convolving the channel estimate with the digitized RF Tx downlink reference signal to obtain the estimated leakage signal. Once the estimated leakage signal is determined, it may be cancelled from the combined downlink signal by the digital signal processor 216 by shifting the estimated leakage signal 180 degrees out of phase and adding it to the combined signal.

In other embodiments (not shown), a digitized Tx downlink reference signal may be obtained directly from the ADC 210. However, using an RF Tx downlink reference signal as shown can have the advantage of allowing the channel estimation algorithms include and account for the distortions associated with the components of the transmitter chain (e.g., DAC 218, analog signal processing block 220, and amplifier 222). This can improve the accuracy of the channel estimation and thus the interference cancellation, which in turn can improve the power transmitted from the amplifier 222 due to the increase isolation.

Further referring to the downlink channel in FIG. 2, once the leakage signal is removed, the downlink signal may be converted to an analog signal by DAC 218. The analog signal may be further processed in the analog domain by analog signal processing block 220. Analog signal processing block 220 may include image rejection filtering, IQ up-conversion, and further RF filtering using, for example, SAW filters for inter-channel interference. Finally, power amplification may be provided by RF power amplifier 222. The amplified downlink signal may subsequently be passed on to duplexer/filter 224 for additional filtering to separate the downlink and uplink channels, and routed to antenna 226 for downlink transmission to the MS 215.

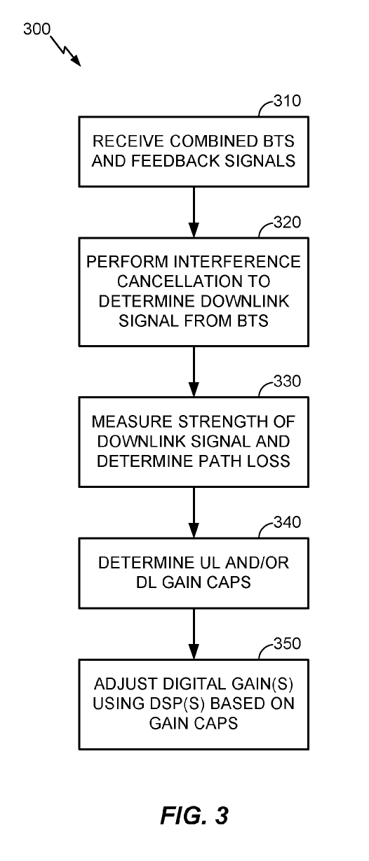

Additionally, after the leakage signal is removed from combined signal, the controller 212 may compute the strength of this signal which is the “desired” received downlink signal from the BTS 205. This may be performed using any conventional technique(s) for determining power, energy, signal magnitude, RSSI, etc. The controller 212 may then estimate the path loss from the computed strength of the downlink signal. The path loss may be determined using conventional techniques, which will be discussed in more detail below in the discussion of FIG. 3. From the estimated path loss, the controller 212 may instruct the digital signal processor 216 to modify the downlink gain cap, and/or instruct the uplink digital signal processor 236 to modify the uplink gain cap. The modifications to the uplink and downlink gain caps may be based upon look-up tables as a function of path loss which can be stored in memory 214.

By adjusting the uplink and/or downlink gain caps, the link imbalance may be altered as a function of path loss, and may allow the appropriate change in the uplink signal level transmitted back to the base station via duplexer/filter 204 and antenna 202, thus reducing the ICR's 200 contribution to the noise floor (e.g., Rise over Thermal—RoT) seen at the BTS's 205 receiver.

Regarding the uplink channel of the ICR 200, uplink signals provided by the MS 215 may be simultaneously received by antenna 226. Similar to the downlink channel described above, a leakage signal, provided over the feedback channel transmitted by antenna 202, is superimposed on the uplink channel at antenna 226. The combined uplink signal is provided to duplexer/filter 224 which filters the combined uplink signal, and routes the signal over the appropriate uplink channel in the ICR 200. The combined uplink signal may be passed to RF amplifier 230, analog signal processing block 232, and ADC 234, which perform similar functions to the uplink signal as the counterpart blocks low noise amplifier 206, analog signal processing block 208, and ADC 210 in the downlink channel. The digitized combined uplink may then be provided to the baseband processor 229, which may perform a separate feedback channel estimation and can use a separate RF Tx uplink reference signal to facilitate the channel estimation. The RF Tx uplink reference may tap off of the output of RF amplifier 242. The analog RF signal may be provided to RF Tx Ref receiver 225 for processing and digitization. The digitized RF Tx uplink reference signal may then be provided to the baseband processor 229 so that the feedback channel for the uplink channel may be estimated by the feedback channel estimation block 246. Similar in the manner described above for the downlink channel, the feedback channel estimate for the uplink channel may be used in conjunction with the Tx reference samples to remove the leakage signal from the combined uplink signal received over antenna 226. Once the leakage signal is removed, the signal may be converted into analog form by DAC 238, and it may be further processed in analog signal processing block 240. The processed uplink signal may be amplified by RF amplifier 242, and then provided to antenna 202 via duplexer/filter 204 for transmission over the uplink back to the BTS 204.

In FIG. 2, the downlink channel and the uplink channel are shown as having separate digital signal processors 216 and 236, respectively. It should be noted that these processors may be physically separate, or may be co-located within the same package. While only one baseband processor 229 is shown for both the downlink channel and the uplink channel in FIG. 2, in other embodiments, each channel may have its own separate baseband processor.

It should appreciated that various embodiments are not restricted to FDD digital base-band ICRs, and the gain control approaches described herein may be used in conjunction with other types of ICRs. Moreover, in embodiment shown in FIG. 2, a direct conversion receiver or zero-IF receiver architecture is used to implement the receiver circuit. In other embodiments, other receiver architecture can be used. The exact implementation of the receiver architecture is not critical to the practice of the present invention.

FIG. 3 is a flow chart of an exemplary process 300 for mitigating the noise contribution of the ICR 200 at the BTS 205 by adjusting the link imbalance of the ICR 200 as a function of path loss. The process may start by receiving a combined signal at antenna 202 which is a superposition of the downlink signal transmitted by the BTS 205 and leakage signal transmitted by ICR's 200 antenna 226 (Block 310). The ICR 200 may then perform interference cancellation to isolate the downlink signal by substantially removing the leakage signal from the combined signal (Block 320). This may be performed in the baseband processor 229 using conventional techniques. For example, as provided above in the description of FIG. 2, the downlink signal may be determined by estimating the feedback channel using MMSE techniques in feedback channel estimation block 228/246, and removing (from the combined signal) a reference signal which has been convolved with the feedback channel estimate in digital signal processor 216. Once the downlink signal has been determined, the strength of the downlink signal may be calculated and the path loss between the BTS 205 and the ICR 202 may be determined (Block 330). The strength of the downlink signal may be a computed power, energy, magnitude, and/or RSSI value which may be determined using conventional techniques. For example, the downlink signal may be a complex signal in (I, Q) format, and the power of each sample may be determined using a sum of squares of the I and Q components. A number of samples may be averaged over a period of time to reduce noise.

Once the strength of the downlink signal is determined, the path loss may be determined by computing the difference between the power of the signal at the BTS (which is known), and the power of the BTS signal arriving at the ICR. Note that the power of the BTS signal arriving at the ICR can be found by mapping the energy of the base band samples after cancellation to a value (e.g., in dBm) of the input signal.

Once the path loss is determined, the controller 212 may determine uplink and/or downlink gains based on the path loss to adjust the link imbalance of the ICR 200 (Block 340). The uplink gain caps and the downlink gain caps may be determined based on look-up tables stored in memory 214, which may be determined according to system and implementation requirements. Once the gain caps are determined, these values may be applied as digital gain adjustments, for example, by having the controller 212 instruct digital signal processor 236 to apply the uplink gain cap, and/or instruct digital signal processor 216 to adjust the downlink gain cap (Block 350).

### Adjusting Signal Level For Improved Quantization

By leveraging the path loss information which can be determined from the measured downlink signal transmitted by the BTS 205, one can appropriately set the digital gains on the uplink and/or downlink (and thus affect the link imbalance) of the ICR. This information may be used to set the gain on the downlink of the ICR to control the level of the initial signal received back at the ICR on the uplink channel from the MS 215. For steady state uplink transmission, the uplink gain cap may be set such so as to control the level of the signal received back at the ICR on the uplink channel. Thus the ICR may “indirectly” control the output of the mobile station's transmit signal level by adjusting the gains at the ICR. In another embodiment, the path loss may be used to “directly” adjust the gain of an RF amplifier on the uplink channel to set the level of the signal prior to analog to digital conversion. In other embodiments, both of the aforementioned approaches may be used to adjust the signal level for improved analog to digital conversion. These types of adjustments can improve overall ICR performance and/or relax the dynamic range requirements of the ADC, thus allowing for a less expensive ADC to be used. For example, by properly setting the gain of the signal at the lower end of the dynamic range of the ADC, signal quality requirements, such as the 18 dB Error Vector Magnitude (EVM) requirement, may be obtained using cost effective hardware. Likewise, by properly setting the gain of the signal at the higher end of the dynamic range of the ADC can improve the headroom of the ICR.

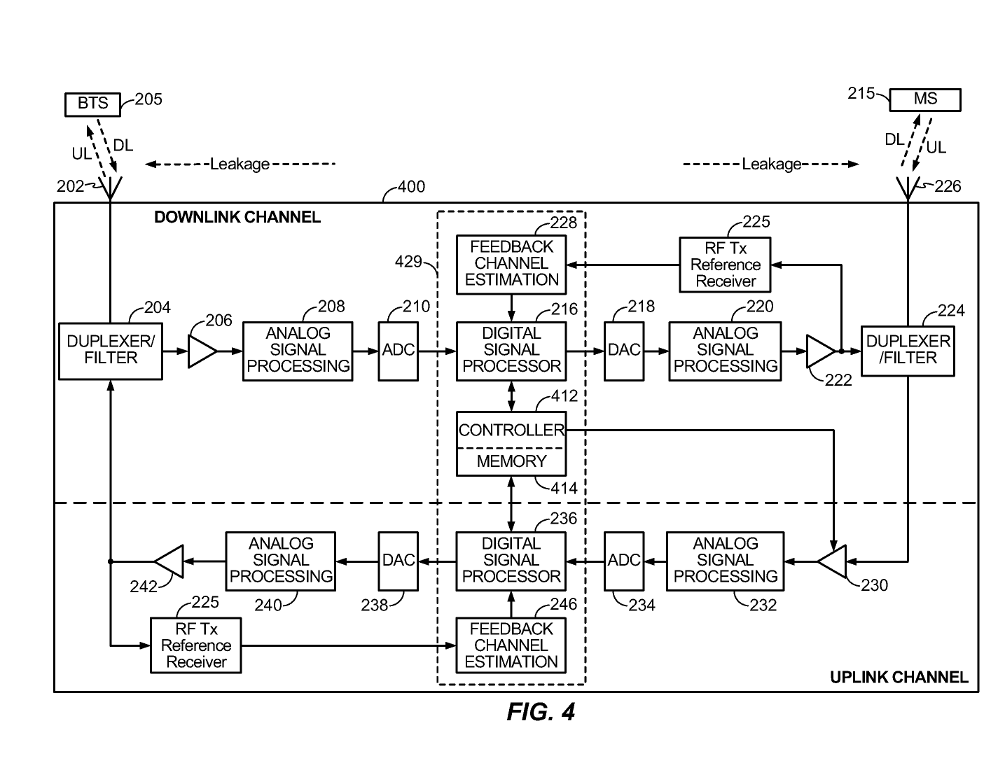

FIG. 4 shows a block diagram of an exemplary ICR 400 which can adjust the digital gains and/or RF amplifier gain(s) based on path loss to improve signal quantization on the uplink channel.

The ICR 400 shown in FIG. 4 may share similar components to the ICR 200 shown in FIG. 2, where these shared components can operate in a similar manner as described above in the description of FIG. 2. Accordingly, these components will share the same reference numbers, and for the sake of brevity, only the differences between ICR 400 and ICR 200 are described below.

In one embodiment, once the signal strength of the downlink signal is computed after interference cancellation, the path loss may be determined in a similar manner as described above for FIG. 2. From the path loss the uplink gain cap and/or the downlink gain cap may be computed. In this instance, controller 412 may select the gain caps so as to indirectly drive the uplink signal level to improve quantization performance by the ADC 234. Here, the ICR 400 may exploit the power control of the MS by setting the uplink gain cap such that the MS power control responds with a desired level for the uplink signal at antenna 226, thus indirectly controlling the transmission level of the MS 215. Accordingly, when adjusting the link imbalance to improve quantization performance, this may be thought of as indirectly controlling the level of the signal on the uplink channel.

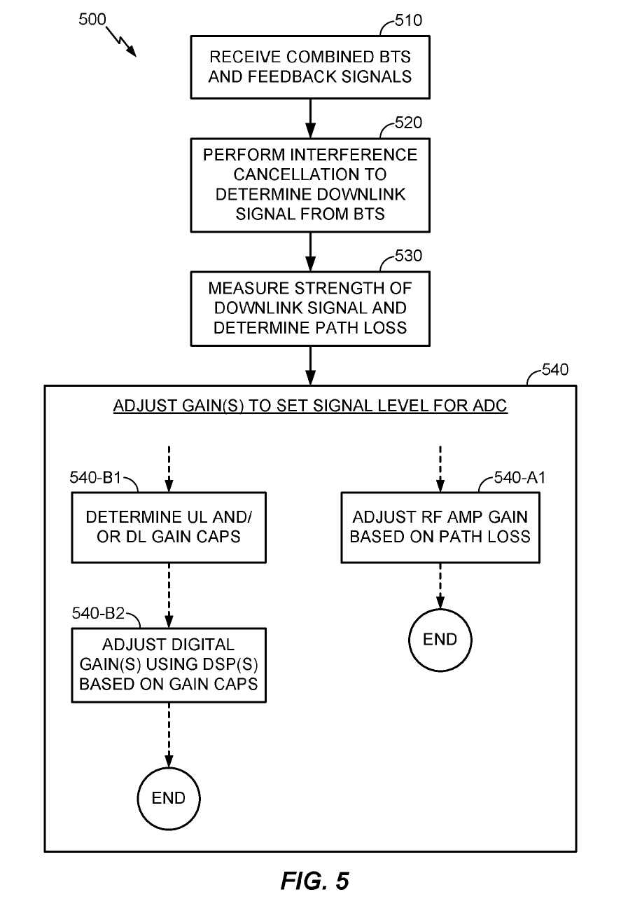

In another embodiment, the signal level on the uplink channel may be directly controlled by appropriately setting the gain of the RF amplifier 230 (which may be realized as a variable gain low noise RF amplifier). In this embodiment, the path loss may be computed as described above in the baseband processor 429, using the downlink signal which is isolated from the combined signal after performing interference cancellation. Using the computed path loss, the controller 412 may determine commands to adjust the RF amplifier 230. These commands may be determined via look-up tables, which are generated based on the relationship between the path loss values and the corresponding uplink signal levels. Adjusting the RF amplifier can improve the quantization performance of the ADC 234. These values in the look-up tables may be determined using calibration techniques. Accordingly, by adjusting gain of the RF amplifier 230, the level of signal in the uplink channel may be directly adjusted relative to the ADC 234 in order to optimize the quantization performance of ADC 234 based on the downlink path loss. In another embodiment, both the “direct” and “indirect” techniques for adjusting the level of the signal on the uplink channel may be combined to optimize quantization performance. Details are discussed in more detail below in the description of FIG. 5.

In another embodiment, the levels of the digital gains may be adjusted to improve signal quantization and reduce the noise contribution of the ICR at the BTS. In this embodiment, separate lookup tables may be maintained for determining separate gain caps for each respective function. In one example, both sets of gain caps may be determined, and the lowest gain caps may be selected for use.

FIG. 5 shows a flow chart of an exemplary process 500 for improving the quantization performance of the uplink channel in the ICR 400 as a function of path loss. The process may start by receiving a combined signal at antenna 202 which is a superposition of the downlink signal transmitted by the BTS 205 and leakage signal transmitted by ICR's 200 antenna 226 (Block 510). The ICR 200 may then perform interference cancellation to isolate the downlink signal by substantially removing the leakage signal from the combined signal (Block 520). This may be performed in the baseband processor 429 using conventional techniques. For example, as provided above in the description of FIG. 4, the downlink signal may be determined by estimating the feedback channel using MMSE techniques in feedback channel estimation block 228/246, and removing (from the combined signal) a reference signal which has been convolved with the feedback channel estimate in digital signal processor 216. Once the downlink signal has been determined, the strength of the downlink signal may be calculated and the path loss between the BTS 205 and the ICR 202 may be determined (Block 530). The strength of the downlink signal may be a computed as noted above in the description of FIG. 3. Once the strength of the downlink signal is determined, the path loss may be computed by using a model which also was explained above in the description of FIG. 3.

Once the path loss is determined, the controller 412 may adjust one or more gain values in the uplink and/or downlink of the ICR 400 to set the signal level for improved uplink quantization performance (Block 540). In one embodiment, this may be performed by determining uplink and/or downlink gain caps for the ICR 400 based on the path loss (Block 540-B1). The uplink gain caps and the downlink gain caps may be determined based on look-up tables stored in memory 414. Once the gain caps are determined, these values may be applied as digital gain adjustments, for example, by having the controller 412 instruct digital signal processor 216 to apply the uplink gain cap, and/or instruct digital signal processor 236 to apply the downlink gain cap (Block 540-B2). As noted above, the adjusting the gain caps in the digital signal processor 216 can change the level of the uplink signal provided to the MS 215, thus influencing the MS, based on its own internal power control algorithms, to change the level of the signal provided back to the ICR 400 on the downlink channel. Utilizing this approach can thus indirectly control level of the uplink signal provided by the MS 215 to optimize quantization by ADC 234.

In an alternative embodiment to Block 540, indicated by the dotted lines in flowchart of FIG. 5, the controller 412 may adjust the gain of the RF amplifier 230 based on path loss (Block 540-A1). The controller may perform this adjustment using a look-up table stored in memory 414. This type of adjustment directly alters the signal level in the uplink channel to improve the quantization performance of the ADC 234.

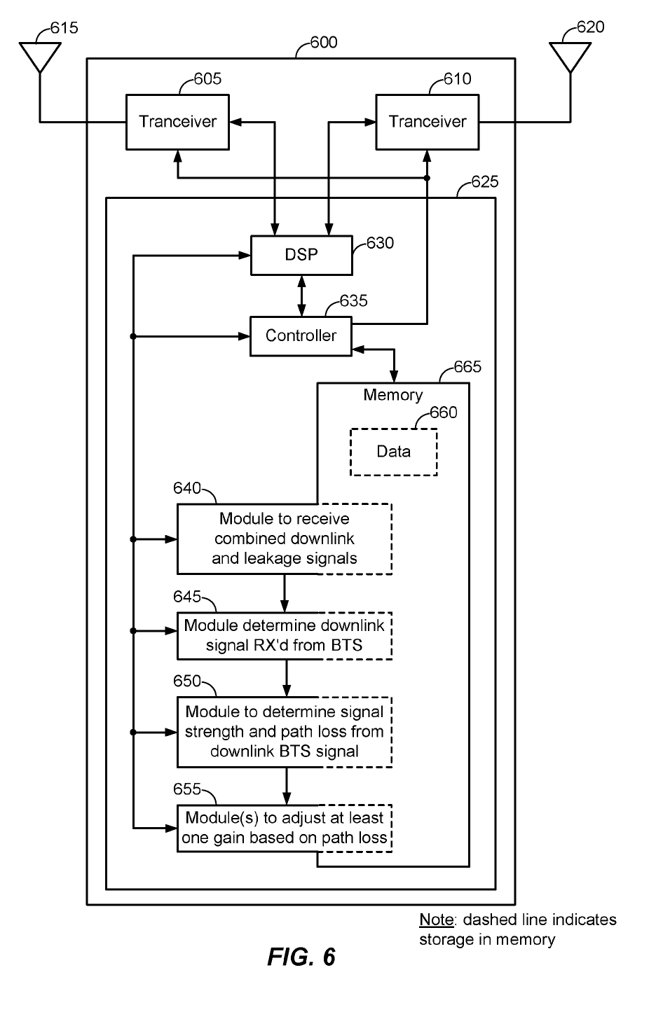

FIG. 6 is a structural block diagram of an exemplary ICR 600 which can be configured to adjust downlink and/or uplink gains in accordance with one or more embodiments, to reduce noise at the BTS and/or adjust signal levels to improve quantization. ICR 600 may include a first transceiver 605 and a second transceiver 610, a donor antenna 615, a server antenna 620, and a baseband processor 625. The baseband processor 625 may further include a digital signal processor 630, a controller 635, modules 640-655, and memory 665.

The first transceiver 605 and second transceiver 610 may exchange RF signals with donor antenna 615 and server antenna 620, respectively, and further exchange modulated digitized baseband signals with the digital signal processor 630. The functionality of the digital signal processor may include performing channel estimation, interference cancellation, and digital gain cap adjustments. The controller 635 can interact with the digital signal processor 630 to receive commands which include instructions for adjusting digital gains. The controller 635 can also interact with transceivers for adjusting gains on RF amplifiers in the uplink channels.

The digital signal processor 630 and/or the controller 635 can work in conjunction with module 640 to receive the combined signal which includes the downlink signal from the BTS 205 and the leakage signal. The digital signal processor 630 and/or the controller 635 can work in conjunction with module 645 to perform interference cancellation and determine the downlink signal received from the BTS.

The digital signal processor 630 and/or the controller 635 can work in conjunction with module 650 to determine the signal strength of the downlink signal, and subsequently compute the path loss between the ICR 600 and the BTS. Both the signal strength and the path loss may be computed using conventional techniques.

The digital signal processor 630 and/or the controller 635 can work in conjunction with module 655 to adjust one or more gains in the ICR 600. To mitigate the ICR's contribution to noise received at the BTS and/or adjust the uplink signal level to optimize quantization, the controller 635 may instruct the digital signal processor 630 to adjust the uplink gain cap and/or the downlink gain cap to alter the link imbalance. In other embodiments, the controller 635 may adjust an RF amplifier in the uplink channel directly change its signal level to optimize quantization in the uplink channel.

In the embodiment depicted in FIG. 6, the modules 640-655 may be realized as a combination of hardware modules which work in conjunction with the digital signal processor 630 and/or the controller 635, and software modules stored in memory 665 which may be executed by the digital signal processor 630 and/or the controller 635. This combination is depicted by portions of the modules 640-655 overlapping memory 665, where the overlapping portions are drawn using dotted lines. In other embodiments, modules 640-655 may be either exclusively hardware based, or exclusively processor and/or controller based, whereby configuration of the digital signal processor 630 and/or the controller 635 may be performed by modules stored in memory 665. The memory 665 may further define a storage area 660 for storing parameters which may be used in the determination of path loss and/or signal strength computed in module 650.

The first transceiver 605 and second transceiver 610 each may incorporate components used in conventional wireless receivers and transmitters. Such components may include variable gain amplifiers, RF power amplifiers, low noise amplifiers, filters, mixers, drivers, modulators, de-modulators, digital-to-analog converters, analog-to-digital converters, etc. Each transceiver may support transceiver operations using their respective antennas. For example, transceiver 605 may support the transmission and reception of signals with a base station using donor antenna 615. The transceiver 610 may support the transmission and reception of signals with a mobile station using server antenna 620. The transceivers 605, 610 may provide digital signals which have been down-converted to baseband and provided to the digital signal processor 630.

The digital signal processor 630 and controller 635 may perform a signal processing and control functions for repeater communications with the mobile device and base station, including echo cancellation and uplink and downlink gain control, as set forth in the aforementioned embodiments, including the process depicted in the flow chart shown in FIG. 3 and/or FIG. 5. The controller 635 may further be functionally coupled to memory 665, which may contain modules having instructions and/or data for utilization by the controller 635 to execute processes described herein. Memory 665 may contained within the baseband processor 625 as shown, reside external to the baseband processor 625, or both. Additionally, the ICR 600 may further utilize one or more processors (not shown) in addition to those contained in the baseband processor 625.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for controlling gains in an interference cancellation repeater. The method may include receiving a combined signal which comprises a downlink signal transmitted from a base station transceiver system (BTS) and a feedback signal; performing interference cancellation on the combined signal to substantially remove the feedback signal from the downlink signal; determining the downlink path loss between the BTS and the interference cancellation repeater based on the downlink signal; and adjusting at least one gain in the interference cancellation repeater based on the path loss. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of controlling gains in an interference cancellation repeater, comprising:
receiving a combined signal which comprises a downlink signal transmitted from a base station transceiver system (BTS) and a feedback signal;
performing interference cancellation on the combined signal to substantially remove the feedback signal from the downlink signal;
determining a path loss between the BTS and the interference cancellation repeater based on the downlink signal after interference cancellation is performed; and
adjusting at least one gain in the interference cancellation repeater based on the path loss.

2. The method of claim 1, wherein computing the downlink path loss further comprises:
computing a signal strength of the downlink signal; and
determining a path loss from the signal strength.

3. The method of claim 1, wherein adjusting at least one gain in the interference cancellation repeater reduces a noise contribution of the interference cancellation repeater at the BTS.

4. The method of claim 3, further comprising:
adjusting a link imbalance between an uplink channel and a downlink channel in the interference cancellation repeater.

5. The method of claim 3, further comprising:
determining an uplink gain cap based on the path loss;
determining a downlink gain cap based on the path loss; and
setting at least one digital gain value based on the uplink gain cap and the downlink gain cap.

6. The method of claim 5, where in the digital gain value is set within a digital signal processor.

7. The method of claim 1, wherein adjusting at least one gain in the interference cancellation repeater controls a signal level for quantization by an analog-to-digital converter.

8. The method of claim 7, further comprising
adjusting a link imbalance between an uplink channel and a downlink channel in the interference cancellation repeater.

9. The method of claim 8, further comprising:
determining an uplink gain cap based on the path loss;
determining a downlink gain cap based on the path loss; and
setting at least one digital gain value based on the uplink gain cap and the downlink gain cap.

10. The method of claim 7, further comprising:
adjusting a gain of a radio frequency amplifier based on path loss.

11. An interference cancellation repeater which controls gains based on a downlink path loss, comprising:
a first transceiver coupled to a donor antenna;
a second transceiver coupled to a serving antenna; and
a baseband processor coupled to the first transceiver and the second transceiver, the baseband processor being configured to:
receive a combined signal which comprises a downlink signal transmitted from a base station transceiver system (BTS) and a feedback signal,
perform interference cancellation on the combined signal to substantially remove the feedback signal from the downlink signal,
determine the path loss between the BTS and the interference-cancellation repeater based on the downlink signal, and
adjust at least one gain in the interference-cancellation repeater based on the path loss.

12. The interference cancellation repeater of claim 11, wherein the baseband processor is further configured to:
compute a signal strength of the downlink signal after interference cancellation is performed; and
determine a path loss from the signal strength.

13. The interference cancellation repeater of claim 11, wherein the baseband processor is further configured to adjust at least one gain in the interference cancellation repeater to reduce a noise contribution of the interference cancellation repeater at the BTS.

14. The interference cancellation repeater of claim 13, wherein the baseband processor is further configured to
adjust a link imbalance between an uplink channel and a downlink channel in the interference cancellation repeater.

15. The interference cancellation repeater of claim 13, wherein the baseband processor is further configured to:
determine an uplink gain cap based on the path loss;
determine a downlink gain cap based on the path loss; and
set at least one digital gain value based on the uplink gain cap and the downlink gain cap.

16. The interference cancellation repeater of claim 15, wherein the at least one digital gain value is set within a digital signal processor.

17. The interference cancellation repeater of claim 11, wherein the baseband processor is further configured to control a signal level for quantization by an analog-to-digital converter.

18. The interference cancellation repeater of claim 17, wherein the baseband processor is further configured to
adjust a link imbalance between an uplink channel and a downlink channel in the interference cancellation repeater.

19. The interference cancellation repeater of claim 18, wherein the baseband processor is further configured to
determine an uplink gain cap based on the path loss;
determine a downlink gain cap based on the path loss; and
set at least one digital gain value based on the uplink gain cap and the downlink gain cap.

20. The interference cancellation repeater of claim 17, wherein the baseband processor is further configured to
adjust a gain of a radio frequency amplifier based on path loss.

21. An interference cancellation repeater which controls gains based on a downlink path loss, comprising:
means for receiving a combined signal which comprises a downlink signal transmitted from a base station transceiver system (BTS) and a feedback signal;
means for performing interference cancellation on the combined signal to substantially remove the feedback signal from the downlink signal;
means for determining a path loss between the BTS and the interference cancellation repeater based on the downlink signal after interference cancellation is performed; and
means for adjusting at least one gain in the interference cancellation repeater based on the path loss.

22. The interference cancellation repeater of claim 21, wherein computing the downlink path loss further comprises:
means for computing a signal strength of the downlink signal; and
means for determining a path loss from the signal strength.

23. The interference cancellation repeater of claim 21, wherein adjusting at least one gain in the interference cancellation repeater reduces a noise contribution of the interference cancellation repeater at the BTS.

24. The interference cancellation repeater of claim 23, further comprising:
means for adjusting a link imbalance between an uplink channel and a downlink channel in the interference cancellation repeater.

25. The interference cancellation repeater of claim 23, further comprising:
means for determining an uplink gain cap based on the path loss;
means for determining a downlink gain cap based on the path loss; and
means for setting at least one digital gain value based on the uplink gain cap and the downlink gain cap.

26. The interference cancellation repeater of claim 25, where in the digital gain value is set within a digital signal processor.

27. The interference cancellation repeater of claim 21, wherein adjusting at least one gain in the interference cancellation repeater controls a signal level for quantization by an analog-to-digital converter.

28. The interference cancellation repeater of claim 27, further comprising
means for adjusting a link imbalance between an uplink channel and a downlink channel in the interference cancellation repeater.

29. The interference cancellation repeater of claim 28, further comprising:
means for determining an uplink gain cap based on the path loss;
means for determining a downlink gain cap based on the path loss; and
means for setting at least one digital gain value based on the uplink gain cap and the downlink gain cap.

30. The interference cancellation repeater of claim 27, further comprising:
means for adjusting a gain of a radio frequency amplifier based on path loss.

31. A non-transitory machine-readable medium comprising instructions, which, when executed by a machine, cause the machine to perform operations, the instructions comprising:
instructions to receive a combined signal which comprises a downlink signal transmitted from a base station transceiver system (BTS) and a feedback signal;
instructions to perform interference cancellation on the combined signal to substantially remove the feedback signal from the downlink signal;
instructions to determine a path loss between the BTS and the interference cancellation repeater based on the downlink signal after interference cancellation is performed; and
instructions to adjust at least one gain in the interference cancellation repeater based on the path loss.

32. The non-transitory machine-readable medium of claim 31, wherein the instructions to compute the downlink path loss further comprise:
instructions to compute a signal strength of the downlink signal; and
instructions to determine a path loss from the signal strength.

33. The non-transitory machine-readable medium of claim 31, wherein the instructions to adjusting at least one gain in the interference cancellation repeater further comprise instructions to reduce a noise contribution of the interference cancellation repeater at the BTS.

34. The non-transitory machine-readable medium of claim 33, further comprising:
instructions to adjust a link imbalance between an uplink channel and a downlink channel in the interference cancellation repeater.

35. The non-transitory machine-readable medium of claim 33, further comprising:
instructions to determine an uplink gain cap based on the path loss;
instructions to determine a downlink gain cap based on the path loss; and
instructions to set at least one digital gain value based on the uplink gain cap and the downlink gain cap.

36. The non-transitory machine-readable medium of claim 35, where in the digital gain value is set within a digital signal processor.

37. The non-transitory machine-readable medium of claim 31, wherein the instructions to adjust at least one gain in the interference cancellation repeater controls a signal level for quantization by an analog-to-digital converter.

38. The non-transitory machine-readable medium of claim 37, further comprising:
instructions to adjust a link imbalance between an uplink channel and a downlink channel in the interference cancellation repeater.

39. The non-transitory machine-readable medium of claim 38, further comprising:
instructions to determine an uplink gain cap based on the path loss;
instructions to determine a downlink gain cap based on the path loss; and
instructions to set at least one digital gain value based on the uplink gain cap and the downlink gain cap.

40. The non-transitory machine-readable medium of claim 37, further comprising:
instructions to adjust a gain of a radio frequency amplifier based on path loss.
